(19) United States
(12) Patent Application Publication
(10) Pub. No.: US 2023/0229134 A1
(43) Pub. Date: Jul. 20, 2023

(54) NUMERICAL CONTROL DEVICE AND NUMERICAL CONTROL METHOD FOR PERFORMING MOVEMENT CONTROL OF MACHINING TOOL BY FIXED CYCLE

(71) Applicant: Fanuc Corporation, Minamitsuru-gun, Yamanashi (JP)

(72) Inventor: Yoshiaki Itou, Minamitsuru-gun, Yamanashi (JP)

(73) Assignee: Fanuc Corporation, Minamitsuru-gun, Yamanashi (JP)

(21) Appl. No.: 18/008,815

(22) PCT Filed: Jun. 8, 2021
(86) PCT No.: PCT/JP2021/021774

§ 371 Date: Dec. 7, 2022

(30) Foreign Application Priority Data
Jun. 10, 2020 (JP) 2020-100675

(51) Int. Cl. G05B 19/402; G05B 19/406

(52) U.S. Cl. CPC G05B 19/402; G05B 19/406; G05B 2219/37434

(57) ABSTRACT

A numerical control device for performing movement control of a machining tool by a fixed cycle includes a main control unit that issues a machining command to a machining device based on a machining program, a machining program analysis unit that pre-reads and analyzes the machining program, a machining state measurement unit that measures a physical quantity indicating a machining state during machining, and a start position determination unit that determines an overlap control start position based on the measured physical quantity, and the main control unit executes overlap control when determining that the machining tool reaches the overlap control start position.

### CROSS REFERENCE TO RELATED APPLICATIONS

This is the U.S. National Phase application of PCT/JP2021/021774, filed Jun. 8, 2021, which claims priority to Japanese Patent Application No. 2020-100675, filed Jun. 10, 2020, the disclosures of these applications being incorporated herein by reference in their entireties for all purposes.

### FIELD OF THE INVENTION

The present invention relates to a numerical control device and a numerical control method for performing movement control of a machining tool by a fixed cycle.

### BACKGROUND OF THE INVENTION

When machining is repeatedly performed to a workpiece by a machining tool in machining of the workpiece, numerical control by a fixed cycle is known. As machining that is carried out at a fixed cycle like this, drilling, boring, tapping and the like are known, for example.

In the numerical control by a fixed cycle like this, a machining program also includes movement control for moving the machining tool from one machining position to the next machining position when machining at the one machining position (for example, a hole or the like) is completed. Whereas, in the movement control of the machining tool like this, a movement command to the drive axis of the moving mechanism of the machining tool is normally executed individually, “overlap control” that overlaps movement commands to a plurality of drive axes may be executed.

As an example of the overlap control like this, Patent Literature 1 discloses a high-speed drilling method (drilling method) for forming a large number of holes in a workpiece by using a machine tool controlled by a numerical control device, that provides an in-position width for a hole bottom for detecting that the tool reaches a commanded hole bottom position during a drilling cycle, an in-position width for positioning for detecting that a tool mounting shaft is positioned in a commanded drilling position, and an in-position width for retracting for detecting that the tool mounting shaft reaches a commanded position for returning during retraction, sets at least one of the in-position width for positioning and the in-position width for retracting to be larger than the in-position width for the hole bottom, adds data for identifying respective blocks to execution format data with respect to a positioning block and a retracting block, at a time of creation of execution format data of respective blocks of an NC program, determines whether the tool reaches the corresponding in-position width based on data for discriminating the positioning, drilling and retracting at an end of pulse distribution based on the execution format data, and starts execution of the next block by reaching the corresponding in-position width. According to the method, it is possible to execute next pulse distribution without waiting for end of tool movement in each axis direction, so that it is possible to shorten the waiting time for starting pulse distribution, and speed up the drilling work.

Further, Patent Literature 2 discloses a numerical control device that starts distribution of a movement command of a next block at a specified timing of start of the next block, during distribution of a movement command of one block commanded by a machining program, by an overlap command, and the specified timing of starting the next block is a time when a remaining movement command amount during movement command distribution becomes a set amount or less. According to the numerical control device, in the middle of distribution of the movement command of one block in the machining program, distribution of the movement command of the next block is started, so that the execution time of the machining program becomes short, and an overlap process can be performed for only a necessary spot and section by the overlap command.

### PATENT LITERATURE

### Patent Literature 1

Japanese Patent Laid-Open No. 64-27838

### Patent Literature 2

Japanese Patent Laid-Open No. 11-39017

### SUMMARY OF THE INVENTION

In the conventional numerical control device and numerical control method described above, it is necessary to describe the commands including the control start position in the machining program in advance for the overlap control when moving to the next machining position after end of machining at one machining position. For example, in Patent Literature 1, it is necessary to specify individual in-position widths in the machining program in advance, and in Patent Literature 2, it is necessary to set the remaining movement command amount for determining the start timing of the next block in advance.

It becomes an additional matter of consideration and a burden for a program creator to describe the start position of the overlap control in advance in the machining program in this way. In particular, when machining by a plurality of fixed cycles is carried out, it is necessary to set the overlap start position for each of individual fixed cycles individually, and the burden increases more.

From the circumstances as described above, a numerical control device and a numerical control method that can automatically identify an overlap start position from a machining program by a fixed cycle are required.

A numerical control device for performing movement control of a machining tool by a fixed cycle according to one aspect of the present invention includes a main control unit that issues a machining command to a machining device based on a machining program, a machining program analysis unit that pre-reads and analyzes the machining program, a machining state measurement unit that measures a physical quantity indicating a machining state during machining, and a start position determination unit that determines an overlap control start position based on the physical quantity, in which the main control unit executes overlap control of the machining tool when determining that the machining tool reaches the overlap control start position.

Further, a numerical control method for performing movement control of a machining tool by a fixed cycle according to one aspect of the present invention includes the steps of, when pre-reading a machining program and issuing a machining command to a machining device, measuring a physical quantity indicating a machining state during machining, determining an overlap control start position based on the physical quantity, and executing overlap control of the machining tool when determining that the machining tool reaches the overlap control start position.

According to one aspect of the present invention, the physical amount indicating the machining state during machining is measured, the overlap control start position is determined based on the physical amount, and the overlap control of the machining tool is executed when it is determined that the machining tool reaches the overlap control start position, so that the overlap start position can automatically be identified from the machining program by a fixed cycle.

### BRIEF DESCRIPTION OF DRAWINGS

FIG. 1 is a block diagram showing a relation between a numerical control device for performing movement control of a machining tool by a fixed cycle and a peripheral device thereof, according to a first embodiment that is a typical example of the present invention.

FIG. 2 is a partial sectional view showing an example of the movement control of the machining tool by a fixed cycle in the first embodiment.

FIG. 3A is a graph showing an example of a physical quantity measured in the first embodiment.

FIG. 3B is a graph showing an example of the physical quantity measured in the first embodiment.

FIG. 4 is a flowchart showing an operation of a numerical control method according to the first embodiment of the present invention.

FIG. 5 is a flowchart showing an operation of a numerical control method according to a modification of the first embodiment.

FIG. 6 is a graph showing an example of a physical quantity measured in a numerical control device according to a second embodiment of the present invention.

FIG. 7 is a partial sectional view showing an example of movement control of a machining tool by a fixed cycle in a third embodiment.

### DETAILED DESCRIPTION OF EMBODIMENTS OF THE INVENTION

Hereinafter, embodiments of a numerical control device and a numerical control method for performing movement control of a machining tool by a fixed cycle according to a typical example of the present invention are described with the drawings.

### First Embodiment

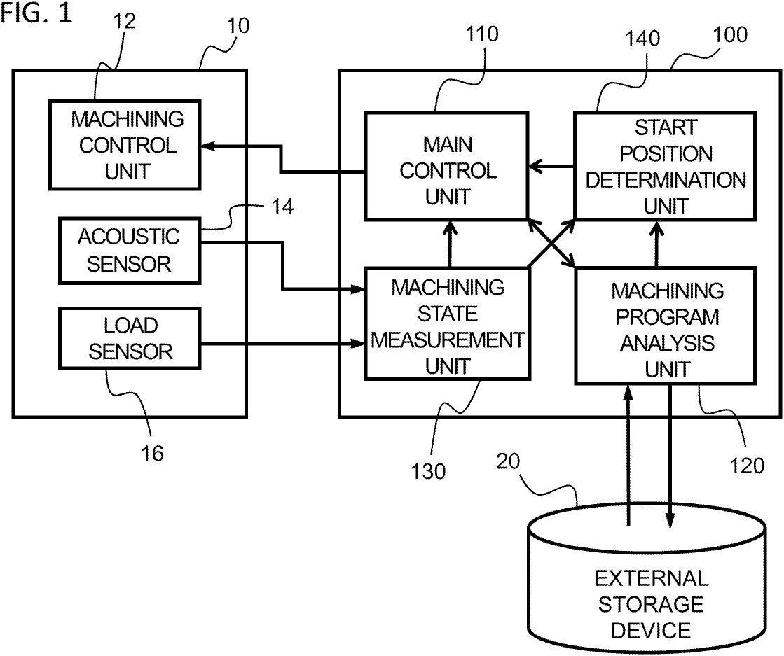

FIG. 1 is a block diagram showing a relation of the numerical control device for performing movement control of a machining tool by a fixed cycle and a peripheral device thereof, according to a first embodiment that is a typical example of the present invention. As shown in FIG. 1, a numerical control device 100 according to the first embodiment includes a main control unit 110 that issues a machining command to a machining device based on a machining program, a machining program analysis unit 120 that pre-reads and analyzes the machining program, a machining state measurement unit 130 that measures a physical quantity indicating a machining state during machining, and a start position determination unit 140 that determines an overlap control start position based on the measured physical quantity, for example.

The numerical control device 100 is connected to a machining device 10 that carries out machining by a fixed cycle or an external storage device 20 communicably with each other via wire, a communication line or the like, issues various control commands to the machining device 10 via the main control unit 110, and receives detection signals detected by various sensors (an acoustic sensor 14 and a load sensor 16, for example) mounted to the machining device 10. Further, the numerical control device 100 takes in a machining program describing a control operation of the machining device 10 from the external storage device 20, and updates the machining program as necessary.

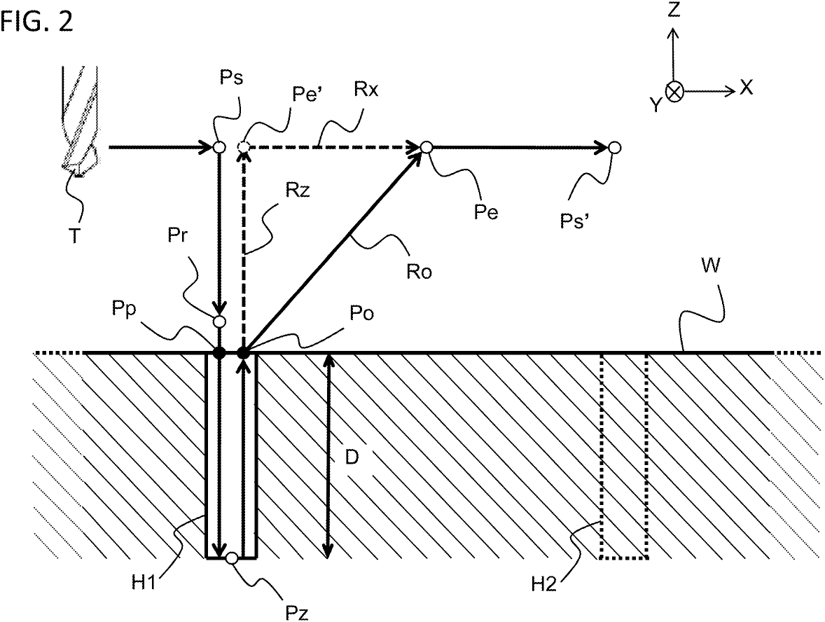

The machining device 10 is configured as a device that can continuously perform drilling, boring, tapping or the like by a fixed cycle to a workpiece W, for example. The machining device 10 is provided with a machining control unit 12 that controls an operation of an entire device including a driving unit (not illustrated) that drives a machining tool (see reference sign T in FIG. 2), and various sensors (the acoustic sensor 14 and the load sensor 16, for example) that detect physical quantities indicating a machining state of the workpiece W. Here, as the acoustic sensor 14 and the load sensor 16, a microphone that obtains sound data in a vicinity of the workpiece W of the machining device 10, a torque sensor that measures torque of a spindle that rotates the machining tool T and the like can be illustrated.

The main control unit 110 is means for issuing an operation command signal to the machining device 10, and generates a command signal to the machining device based on information on a block of the machining program that is pre-read in the machining program analysis unit 120, or an overlap control start position determined in the start position determination unit 140 described later, for example. Note that the main control unit 110 may have a function of receiving data of the various physical quantities indicating the machining state from the machining state measurement unit 130 and determining an operation state of the machining device 10 based on the physical quantities.

The machining program analysis unit 120 includes a function of determining what kind of control command is included in the block of the machining program that is pre-read by sequentially pre-reading and analyzing the block of the machining program from the external storage device 20, and a function of temporarily storing and retaining the pre-read block of the machining program, as an example thereof. As for a normal machining routine of the pre-read block of the machining program, the machining program analysis unit 120 sends the block to the main control unit 110, and when the pre-read block includes an overlap control subroutine, the machining program analysis unit 120 sends the block to the main control unit 110 and the start position determination unit 140 described later. Further, the machining program analysis unit 120 may include a function of not only reading the machining program by being connected to the external storage device 20, but also performing addition to or correction of the machining program based on a machining result from the main control unit 110.

The machining state measurement unit 130 is connected to the various sensors (the acoustic sensor 14 and the load sensor 16, for example) of the machining device 10, and receives the detection signals from these sensors at each predetermined control clock, as an example thereof. The received physical quantity (acoustic data or load data of the machining tool T, for example) from each of the various sensors is sent in real time to the main control unit 110 that generates and transmits a control command and the start position determination unit 140 that determines an overlap control start position (see reference sign Po in FIG. 2).

The start position determination unit 140 determines the overlap control start position Po at which the overlap control is started based on the physical quantity from each of the various sensors in real time that is measured in the machining state measurement unit 130. Subsequently, the overlap control start position Po determined in the start position determination unit 140 is sent to the main control unit 110, and the main control unit 110 that receives it transmits a command signal to execute the overlap control of the machining tool, when determining that a position of the machining tool T reaches the overlap control start position Po.

FIG. 2 is a partial sectional view showing an example of movement control of the machining tool by a fixed cycle in the first embodiment. Here, a case of performing drilling that continuously forms a plurality of holes H1 and H2 in the workpiece W is illustrated as typical machining by a fixed cycle.

As shown in FIG. 2, in the machining control according to the first embodiment, the machining tool T is firstly moved to a machining start position Ps of the hole H1 in the workpiece W. At this time, the machining tool T may be in a rotating state in advance, or may rotate at the machining start position Ps.

Next, the machining tool T is moved to a reference position Pr while rotating, stops at the reference position Pr once, and thereafter starts cutting in a Z direction toward the workpiece W. At this time, the machining tool T contacts the workpiece W at a first contact position Pp with a workpiece W surface, and machining is started.

Next, the machining tool T that is rotating performs cutting to a hole bottom position Pz at a predetermine depth D. At this time, cutting to the hole bottom position Pz from the contact position Pp may be performed by being divided into a plurality of times in consideration of a load onto the machining tool T, but a case in which the machining tool T performs cutting to the hole bottom position Pz by a single operation is illustrated here.

The machining tool T that ends drilling to the hole bottom position Pz is returned by fast-feeding in the Z direction to the overlap control start position Po that is assumed to be at a same height as the surface of the workpiece W while rotating. In the first embodiment according to the present invention, movement control of the machining tool T by overlap control that superimposes (overlaps) feeding in the Z direction and feeding in an X direction of the machining tool T is executed when it is determined that the machining tool T that is returned from the hole bottom position Pz reaches the overlap control start position Po.

In other words, as shown in FIG. 2, normally, the machining tool T that is returned from the hole bottom position Pz by fast-feeding moves to a return position Pe′ through a route Rz in the Z direction, thereafter is fed fast through a route Rx in the X direction, and is moved to a machining start position Ps′ of the next hole H2. In contrast to this, in the overlap control, the machining tool T that is returned from the hole bottom position Pz by fast-feeding is switched to the overlap control when it is determined that the machining tool T returns to the overlap control start position Po, and is fed fast through an overlap route Ro to be moved to the machining start position Ps′ of the next hole H2. Note that in FIG. 2, the overlap control in two dimensions is explained as the sectional view, but the overlap control may be configured to perform movement control by superimposing movements in respective directions of X, Y and Z.

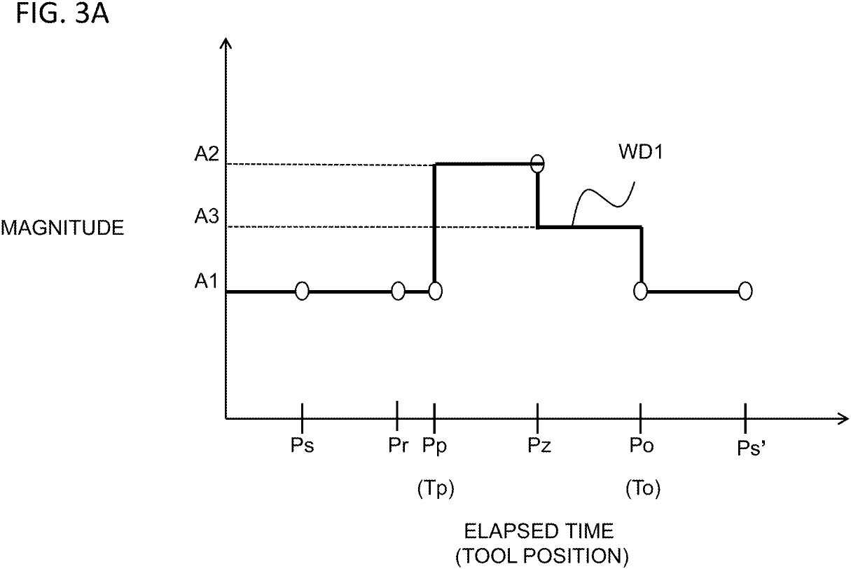

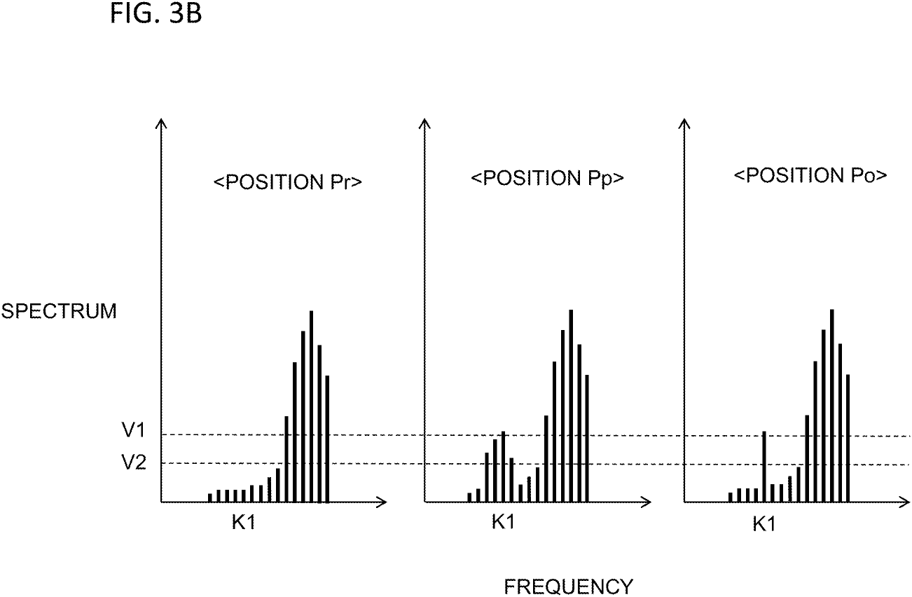

FIG. 3A and FIG. 3B are graphs each showing an example of the physical quantity measured in the first embodiment. In the first embodiment, the case of using sound data measured in the acoustic sensor 14 of the machining device 10 shown in FIG. 1 is illustrated.

As shown in FIG. 3A, in the machining control by a fixed cycle according to the first embodiment, sound data WD1 changes among a first magnitude level A1 while the machining tool T is moving without contact with the workpiece W, a second magnitude level A2 while the machining tool T is in contact with the workpiece W and is performing cutting, and a third magnitude level A3 while the machining tool T is performing a tool return to the overlap control start position Po from the hole bottom position Pz.

In other words, in a section in which the machining tool T passes through the reference position Pr from the machining start position Ps to reach the contact position Pp shown in FIG. 2, the sound data WD1 remains at the first magnitude level A1, and changes to the second magnitude level A2 when the machining tool T contacts the workpiece W at the contact position Pp (that is, a time Tp) and cutting is started. Subsequently, in a cutting section to the hole bottom position Pz, the sound data WD1 remains at the second magnitude level A2, and changes to the third magnitude level A3 when the machining tool T reaches the hole bottom position Pz and is switched to the tool return in which the machining tool T is extracted.

Next, in a tool return section from the hole bottom position Pz to the overlap control start position Po (that is, a time To), the sound data WD1 remains at the third magnitude level A3, and when a tip end of the machining tool T is extracted from the workpiece W, the sound data WD1 returns to the first magnitude level A1. Since there is no contact between the machining tool T and the workpiece W thereafter, the sound data WD1 remains at the first magnitude level A1 in a section from the overlap control start position Po to the next machining start position Ps′.

From the above, in the first embodiment, if the sound data WD1 is measured as the physical quantity during machining, and a timing at which the third magnitude level A3 is switched to the first magnitude level A1 can be determined, the overlap control start position Po for switching to the overlap control can be directly detected during machining at a fixed cycle. In other words, the numerical control device according to the first embodiment of the present invention operates to measure the sound data WD1 as the physical quantity indicating the machining state during machining, determine the overlap control start position Po based on the sound data WD1, and execute the overlap control when determining that the machining tool T reaches the overlap control start position Po.

Here, the sound data WD1 as the physical quantity indicating the machining state illustrated in the above is collected by the acoustic sensor 14 such as a microphone as an example thereof, and therefore depending on a position or an area of the machining device 10 where the acoustic sensor 14 is placed, data containing a lot of noise and the like may be obtained. In such a case, there can be illustrated a method of extracting a representative value of frequency components due to contact of the machining tool T and the workpiece W by subjecting the measured sound data WD1 to frequency analysis as shown below.

For example, as shown in FIG. 3B, frequency analysis data in which each of sound data WD1 at the reference position Pr, the contact position Pp and the overlap control start position Po shown in FIG. 3A is expressed as a spectrum for each frequency is extracted. From the frequency analysis data, it is possible to determine that the machining tool T is in contact with the workpiece W when a spectrum intensity in a specific frequency K1 exceeds a first threshold V1, for example.

Further, as another example, it is possible to determine whether the machining tool T is under a cutting operation or a tool return operation, when some low frequency components around the frequency K1 exceeds a second threshold, as shown in the frequency analysis data at the contact position Pp. In other words, it is possible to estimate a present machining position by setting a plurality of thresholds of the spectrum intensity.

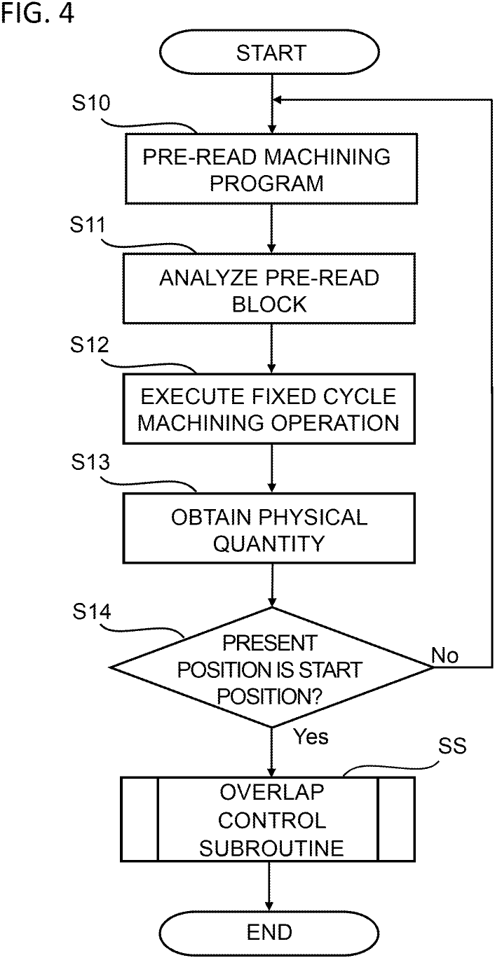

FIG. 4 is a flowchart showing an operation of the numerical control method according to the first embodiment of the present invention. As shown in FIG. 4, the machining program analysis unit 120 of the numerical control device 100 firstly pre-reads a block of the machining program from the external storage device 20 (step S10) .

Next, what operation or command is contained in the block of the machining program that is pre-read by the machining program analysis unit 120 is analyzed (step S11). At this time, the pre-read block is temporarily accumulated in the machining program analysis unit 120, and as described above, the pre-read block is sent to the main control unit 110 and the start position determination unit 140 for each operation command.

Subsequently, the main control unit 110 issues a command to execute the machining operation by a fixed cycle based on the block analyzed in step S11 (step S12). During execution of normal machining, the main control unit 110 obtains the physical quantity (sound data WD1) indicating the machining state via the machining state measurement unit 130 (step S13).

Subsequently, the main control unit 110 determines whether the present position of the machining tool T is the overlap control start position Po based on the physical quantity obtained in step S13 (step S14). As the determination method at this time, the method described by using FIG. 3 described above can be used as an example thereof.

When it is determined that the present position of the machining tool T does not reach the overlap control start position Po in step S14, the flow returns to step S10 and the operations from step S10 are repeated. On the other hand, when it is determined that the present position of the machining tool T reaches the overlap control start position Po, the flow proceeds to step SS to shift to an overlap control subroutine.

The “overlap control subroutine” shown as step SS is movement control of the machining tool T that superimposes (overlaps) feeding in the Z direction and feeding in the X direction of the machining tool T, for example, as shown in FIG. 2 as an example thereof. Since a conventionally known method can be applied as the “overlap control subroutine” like this, explanation thereof is omitted here.

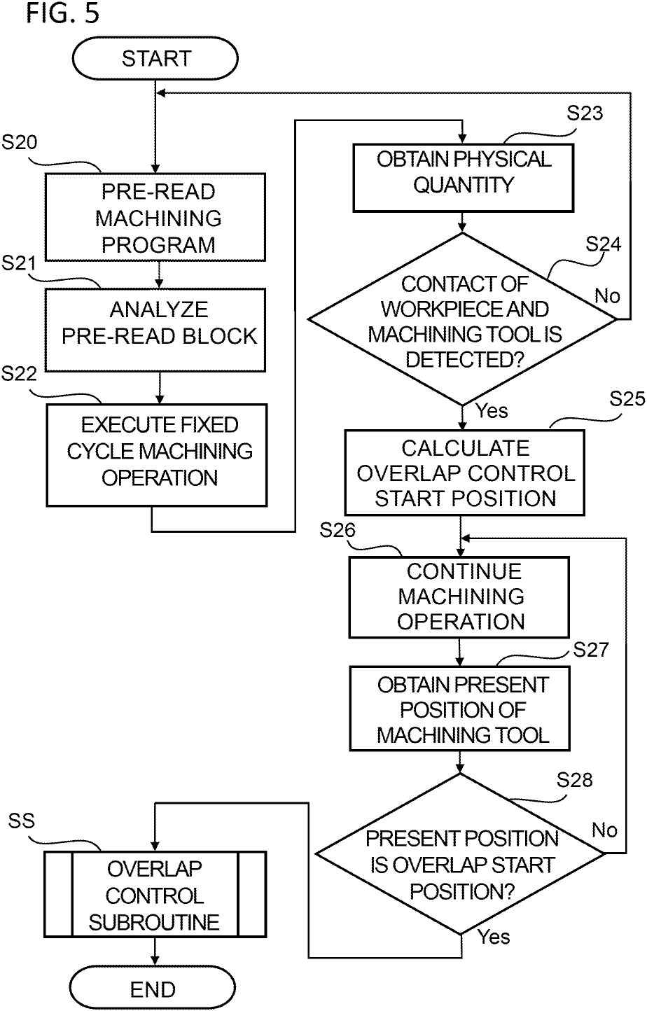

FIG. 5 is a flowchart showing an operation of a numerical control method according to a modification of the first embodiment. As shown in FIG. 5, the machining program analysis unit 120 of the numerical control device 100 pre-reads a block of the machining program from the external storage device 20 as in the case of FIG. 4 (step S20) .

Next, what operation or command is contained in the block of the machining program that is pre-read by the machining program analysis unit 120 is analyzed (step S21). Subsequently, the main control unit 110 issues a command to execute the machining operation by a fixed cycle based on the block that is analyzed in step S21 (step S22).

Next, during execution of normal machining, the main control unit 110 obtains the physical quantity (sound data WD1) indicating the machining state via the machining state measurement unit 130 (step S23) and determines whether the machining tool T contacts the workpiece W first (that is, whether reaches the contact position Pp shown in FIG. 2) based on the physical quantity obtained in step S23 (step S24) .

As the determination method at this time, there is cited a method that detects a moment at which the sound data WD1 reaches the second magnitude level A2 at the contact position Pp at which the machining tool contacts the workpiece first, in the sound data WD1 shown in FIG. 3A or the like as an example thereof. Further, the determination method may a method for determining whether it is the contact position Pp, by using the frequency analysis shown in FIG. 3B described above.

When it is determined that the machining tool T does not contact the workpiece W first in step S24, the flow returns to step S20 to repeat the operations from step S20. On the other hand, when it is determined that the machining tool T contacted the workpiece W, the flow proceeds to step S25.

Next, the start position determination unit 140 determines the overlap control start position Po to be a determination standard for switching to the overlap control later by calculation, and sends information on the overlap control start position Po that is determined to the main control unit 110 (step S25). At this time, as a method for determining the overlap control start position Po, for example, a distance (depth) D from the surface of the workpiece W to the hole bottom position Pz is determined as a control value, and therefore the overlap control start position Po can be calculated as “Po = Pp + 2D” as a cumulative distance.

Subsequently, the main control unit 110 issues a command to continue the machining operation by the present block (step S26), and thereafter obtains the present position of the machining tool T in the machining control state (step S27). Subsequently, the main control unit 110 determines whether the obtained present position corresponds to the overlap control start position Po calculated in step S25 (step S28).

When it is determined that the present position of the machining tool T does not correspond to the overlap control start position Po in step S28, the flow returns to step S26 and the operations from step S26 are repeated. On the other hand, when it is determined that the present position of the machining tool T corresponds to the overlap control start position Po, the flow proceeds to step SS to shift to the overlap control subroutine. Subsequently, as in the case of FIG. 4, the flow is ended after the overlap control subroutine is carried out.

As described above, the numerical control device and the numerical control method according to the first embodiment of the present invention are configured to measure the physical quantity indicating the machining state during machining, determine the overlap control start position based on the physical quantity, and execute the overlap control of the machining tool when determining that the machining tool reaches the overlap control start position, and therefore can automatically identify the overlap start position from the machining program by a fixed cycle.

Note that in the first embodiment, the case of obtaining the sound data WD1 by using the acoustic sensor 14 is illustrated, but as the similar data, the case of obtaining vibration data by mounting a vibration sensor on the machining device 10 may be adopted, for example. Since the vibration sensor can be directly mounted on a component of the machining device 10 in this case, data with less noise can be obtained.

### Second Embodiment

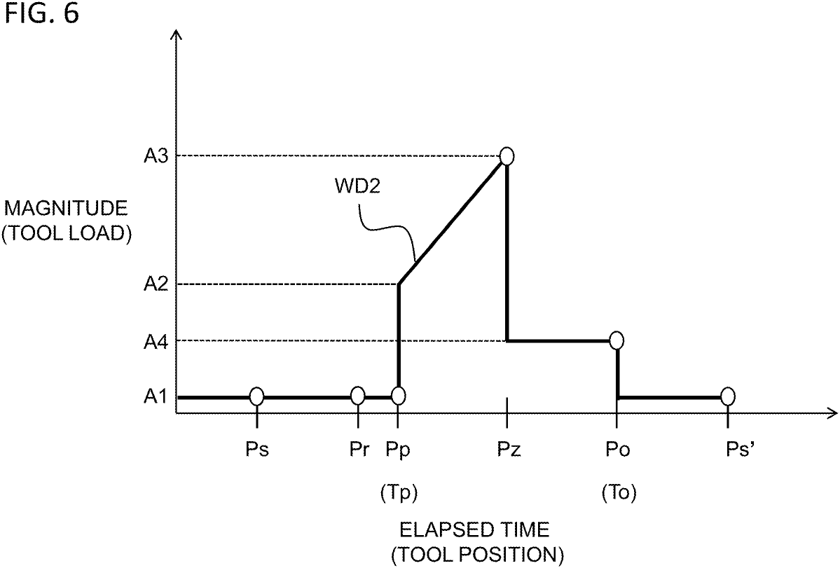

FIG. 6 is a graph showing an example of a physical quantity measured in a numerical control device according to a second embodiment of the present invention. In the second embodiment, as for components that are the same as or common to the components in the first embodiment in the block diagram, flowcharts and the like shown in FIG. 1 to FIG. 5 and can be adopted, those components are assigned with the same reference signs and redundant explanation thereof is omitted.

In machining control at a fixed cycle according to the second embodiment, a physical quantity indicating a state of a machining tool T during machining is directly obtained, instead of the sound data WD1 measured by the acoustic sensor 14. As the physical quantity like this, torque during machining that is measured by a torque sensor provided at a spindle that rotates the machining tool T is used as load data WD2 as an example thereof.

As shown in FIG. 6, the load data WD2 changes among a first magnitude level A1 while the machining tool T is moving without contact with a workpiece W, a second magnitude level A2 that is a load at a contact position Pp (that is, a time Tp) at a moment at which the machining tool T is in contact with the workpiece W and start cutting, a third magnitude level A3 that is a load at a hole bottom position Pz at which the machining tool T cuts into the workpiece W most deeply, and a fourth magnitude level A4 while the machining tool T performs a tool return from the hole bottom position Pz to an overlap control start position Po (that is, a time To).

That is, in a section in which the machining tool T reaches the contact position Pp through a reference position Pr from a machining start position Ps shown in FIG. 2, the load data WD2 remains at the first magnitude level A1, and changes to the second magnitude level A2 when the machining tool T contacts the workpiece W at the contact position Pp and cutting is started. Subsequently, in a cutting section to the hole bottom position Pz, the load data WD2 continuously increases from the second magnitude level A2 to the third magnitude level A3. Thereafter, when the machining tool T reaches the hole bottom position Pz and is switched to the tool return in which the machining tool T is extracted, the load data WD2 changes to the fourth magnitude level A4.

Next, in the tool return section from the hole bottom position Pz to the overlap control start position Po, the load data WD2 remains at the fourth magnitude level A4, and when a tip end of the machining tool T is extracted from the workpiece W, the load data WD2 returns to the first magnitude level A1. Since there is no contact between the machining tool T and the workpiece W thereafter, the load data WD2 remains at the first magnitude level A1 in a section from the overlap control start position Po to a next machining start position Ps′.

From the above, in the second embodiment, if the load data WD2 is measured as the physical quantity during machining, and a timing at which the load data WD2 is switched from the fourth magnitude level A4 described above to the first magnitude level A1 can be determined, the overlap control start position Po for switching to the overlap control can be directly detected during machining at a fixed cycle. Thus, the numerical control device according to the second embodiment of the present invention operates to measure the load data WD2 as the physical quantity indicating the machining state during machining, determine the overlap control start position Po based on the load data WD2, and execute the overlap control when determining that the machining tool T reaches the overlap control start position Po.

As described above, the numerical control device and the numerical control method according to the second embodiment of the present invention can directly measure the physical quantity indicating the machining state of the machining tool, and therefore can determine the timing for shifting to the overlap control more precisely, in addition to the effect obtained in the first embodiment.

### Third Embodiment

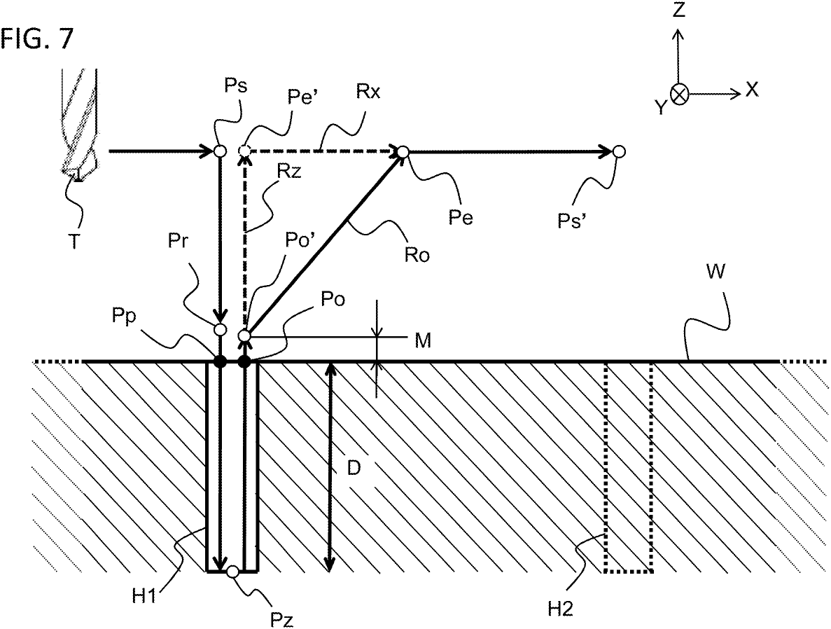

FIG. 7 is a partial sectional view showing an example of movement control of a machining tool by a fixed cycle in a third embodiment. In the third embodiment, as for components that are the same as or common to the components of the first embodiment in the block diagram, flowcharts and the like shown in FIG. 1 to FIG. 5 and can be adopted, those components are also assigned with same reference signs and redundant explanation thereof is also omitted.

As shown in FIG. 7, in machining control according to the third embodiment, a machining tool T is moved to a reference position Pr via a machining start position Ps similarly to the case of the first embodiment. At this time, the machining tool T may be in a rotating state in advance, or may rotate at the machining start position Ps.

Next, the machining tool T contacts a workpiece W at a contact position Pp to start cutting in a Z direction while rotating, and perform cutting to a hole bottom position Pz at a predetermined depth D. At this time, cutting to the hole bottom position Pz from the contact position Pp may be performed by being divided into a plurality of times in consideration of a load onto the machining tool T, similarly to the case of the first embodiment.

The machining tool T that ends drilling to the hole bottom position Pz is returned by fast-feeding in the Z direction to a same height as a surface of the workpiece W while rotating. At this time, in the third embodiment, a margin-included control start position Po′ in which a predetermined margin movement amount M is added in an extraction direction (Z direction) to an overlap control start position Po shown in the first embodiment is obtained by calculation, and the margin-included control start position Po′ is set as a determination standard of overlap control start.

Thus, in the third embodiment, movement control of the machining tool T by overlap control that superimposes (overlaps) feeding in the Z direction and feeding in an X direction of the machining tool T is executed, when it is determined that the machining tool T that is returned from the hole bottom position Pz reaches the margin-included control start position Po′. Thereby, in the first embodiment, the overlap control start position Po is virtually located at the surface of the workpiece W, whereas in the third embodiment, a start position of the overlap control is a position away from the surface of the workpiece W by the margin movement amount M.

As described above, the numerical control device and the numerical control method according to the third embodiment of the present invention can reduce a risk that the machining tool interferes with the surface of the workpiece when superimposing a movement component in the X direction by the overlap control, by setting the start position of the overlap control at the position away from the surface of the workpiece by the margin movement amount, in addition to the effects obtained in the first and second embodiments.

Note that the present invention is not limited to the above described embodiments, and can be properly changed within the range without departing from the gist. In the present invention, modifications of arbitrary components of the embodiments, or omissions of arbitrary components of the embodiments are possible within the scope of the invention.

### REFERENCE SIGNS LIST

10 Machining device
12 Machining control unit
14 Acoustic sensor
16 Load sensor
20 External storage device
100 Numerical control device
110 Main control unit
120 Machining program analysis unit
130 Machining state measurement unit
140 Start position determination unit
Ps Machining start position
Pr Reference position
Pp Contact position
Pz Hole bottom position
Po Overlap control start position
Po′ Margin-included control start position

1. A numerical control device for performing movement control of a machining tool by a fixed cycle, including:
a main control unit that issues a machining command to a machining device based on a machining program;
a machining program analysis unit that pre-reads and analyzes the machining program;
a machining state measurement unit that measures a physical quantity indicating a machining state during machining; and
a start position determination unit that determines an overlap control start position based on the physical quantity,
wherein the main control unit executes overlap control of the machining tool when determining that the machining tool reaches the overlap control start position.

2. The numerical control device according to claim 1, wherein the overlap control start position is determined based on a change of the physical quantity.

3. The numerical control device according to claim 2, wherein the overlap control start position is determined based on the physical quantity at a first contact position of a workpiece and the machining tool.

4. The numerical control device according to claim 1, wherein the overlap control start position is determined by adding a predetermined margin movement amount.

5. The numerical control device according to claim 1, wherein the physical quantity is a machining sound or vibration during machining.

6. The numerical control device according to claim 1, wherein the physical quantity is a machining load to the machining tool during machining.

7. A numerical control method for performing movement control of a machining tool by a fixed cycle, comprising the steps of:
when pre-reading a machining program and issuing a machining command to a machining device,
measuring a physical quantity indicating a machining state during machining;
determining an overlap control start position based on the physical quantity; and
executing overlap control of the machining tool when determining that the machining tool reaches the overlap control start position.

8. The numerical control method according to claim 7, wherein the overlap control start position is determined based on a change of the physical quantity.

9. The numerical control method according to claim 8, wherein the overlap control start position is determined based on the physical quantity in a first contact position of a workpiece and the machining tool.

10. The numerical control method according to claim 7, wherein the overlap control start position is determined by adding a predetermined margin movement amount.

11. The numerical control method according to claim 7, wherein the physical quantity is a machining sound or vibration during machining.

12. The numerical control method according to claim 7, wherein the physical quantity is a machining load to the machining tool during machining.
